(19) United States
(12) Patent Application Publication
(10) Pub. No.: US 2008/0190995 A1
(43) Pub. Date: Aug. 14, 2008

(54) Welding tape and method of use

(75) Inventor: Gary Litman, Framingham, MA (US)

Correspondence Address: WOLF GREENFIELD & SACKS, P.C., 600 ATLANTIC AVENUE, BOSTON, MA, 02210-2206, US

(73) Assignee: Venture Tape Corp., Rockland, MA (US)

(21) Appl. No.: 11/706,036

(22) Filed: Feb. 13, 2007

(51) Int. Cl. B32B 7/02

(52) U.S. Cl. 228/214; 428/447

(57) ABSTRACT

A protective tape for use while welding together two metal components is provided. The protective tape includes a non-metal carrier sheet that is extensible and substantially flexible such that it closely conforms to irregular surfaces of a metal component. The protective tape also includes a covering on a first side of the carrier sheet that shields the carrier sheet from weld spatter, and an adhesive on a second side of the carrier sheet. A method of welding metal components together using the protective tape is also provided.

### FIELD OF INVENTION

The present invention relates generally to protective tapes, and more particularly to an improved protective tape for welding applications and related methods for using the protective tape while welding metal components.

### BACKGROUND OF INVENTION

Weld spatter may arise when welding two metal components together. Weld spatter occurs around a welding location when the metal welding material heats up and small quantities of molten welding material spray outwardly, often landing on the metal components around the welding location. As the weld spatter cools, it may bond to the components making it difficult to remove.

In some welding applications, the existence of weld spatter around the welding location is not a concern. For example, if the location of the weld is not visible in the final product or if the appearance of the final product is of minor significance, weld spatter may remain on the component.

In other welding applications, the appearance of the component is more critical, and the weld spatter must be removed. One welding application where appearance of the final product is critical is in the manufacture of automobiles. Typically, various metal components of an automobile are welded together and weld spatter may remain on these components. When the welding occurs in a location that is visible in the final product, such as around a car door, window, trunk, or car hood, the weld spatter must be removed from the component. Removal of the weld spatter may be complicated by the fact that before welding, these automobile components may be metal plated for corrosion resistance. For example, as shown in FIG. 1, a metal component 110 has a zinc plating layer 120 to prevent corrosion. When grinding weld spatter 102 from the plated component 110 one must be careful to remove the weld spatter 102 without also removing the protective plating layer 120. To prevent removal of the protective plating layer 120, the conventional approach to removing weld spatter 102 is to manually grind the weld spatter off the component. However, manually grinding weld spatter 102 is time consuming and may result in surface variations on the component. As shown in FIG. 2, manually grinding off weld spatter 102 may lead to undesirable rough spots on the component where some weld spatter 102 remains. Also, grinding off weld spatter may lead to portions 122 of the plating layer 120 being removed which may expose portions 112 of the component 110 to corrosion.

One known approach for minimizing some of the problems associated with weld spatter is to use a protective tape. The protective tape is placed on a component around a welding location such that weld spatter lands on the protective tape instead of landing on the component. The assignee of this patent application, Venture Tape, sells two representative protective tapes under the product numbers 3244 and 3243. Both of these protective tapes have an aluminum carrier sheet with an acrylic adhesive on one side of the carrier sheet. Although these protective tapes are useful in many applications, they may be unsuitable for other applications.

### SUMMARY OF INVENTION

In one aspect, a protective tape for use while welding together two metal components is disclosed. In particular, the protective tape includes a non-metal carrier sheet that is extensible and substantially flexible such that it closely conforms to irregular surfaces of a metal component. The carrier sheet is heat resistant such that it has a melting temperature of at least 200° C. The protective tape also includes a covering on a first side of the carrier sheet that shields the carrier sheet from weld spatter and an adhesive on a second side of the carrier sheet that is constructed to adhere to the metal component.

In another aspect of the invention, a protective tape for use while welding together two metal components is disclosed. The protective tape includes a non-metal carrier sheet that is extensible and substantially flexible such that it closely conforms to irregular surfaces of a metal component and a covering on a first side of the carrier sheet that shields the carrier sheet from weld spatter. The protective tape further includes a crosslinked adhesive on a second side of the carrier sheet that is constructed to adhere to the metal component, where the adhesive is rubber-based or urethane-based.

In yet another aspect of the invention, a method of welding metal components together is disclosed. The method includes the steps of metal plating a metal component and providing a protective tape that includes a non-metal carrier sheet, a covering on a first side of the carrier sheet, and an adhesive on a second side of the carrier sheet. The method further includes the step of applying the protective tape over at least a portion of the metal plated component adjacent a welding location, where the protective tape is applied such that the carrier sheet is extended and flexed to closely conform to an irregular surface of the metal component and the adhesive adheres to the metal component. The method further includes the step of welding the metal plated component at the welding location, where the covering on the carrier sheet shields the carrier sheet from weld spatter. Thereafter the protective tape is removed from the component such that weld spatter on the protective tape is removed from the component with the removal of the protective tape.

In another aspect of the invention, the combination of at least two metal components defining a welding location therebetween and a protective tape applied to at least one of the metal components adjacent the welding location is disclosed. The protective tape includes a non-metal carrier sheet that is extensible and substantially flexible such that it closely conforms to irregular surfaces of the metal component. The carrier sheet is heat resistant such that it has a melting temperature of at least 200° C. The protective tape also includes a covering on a first side of the carrier sheet that shields the carrier sheet from weld spatter and an adhesive on a second side of the carrier sheet that is constructed and arranged to adhere to the metal component.

### BRIEF DESCRIPTION OF DRAWINGS

The accompanying drawings are not intended to be drawn to scale. In the drawings, each identical or nearly identical component that is illustrated in various figures is represented by a like numeral. For purposes of clarity, not every component may be labeled in every drawing.

Various embodiments of the invention will now be described, by way of example, with reference to the accompanying drawings, in which:

FIG. 1 is a schematic cross-sectional view of a metal plated component with weld spatter;

FIG. 2 is a schematic cross-sectional view of the metal plated component illustrated in FIG. 1 after grinding to remove the weld spatter;

FIG. 3 is a schematic perspective view of a protective tape according to one embodiment of the present invention;

FIG. 4 is a schematic side view of a protective tape according to one embodiment of the invention being applied to a component;

FIG. 5 is a schematic side view of a protective tape according to another embodiment being applied to another component;

FIG. 6 is a schematic side view of the protective tape of FIG. 5 with weld spatter;

FIG. 7 is a schematic side view of the protective tape of FIGS. 5-6 as the tape is being removed from the component; and

FIG. 8 is a schematic perspective view of a robotic tape applicator applying a protective tape to a component.

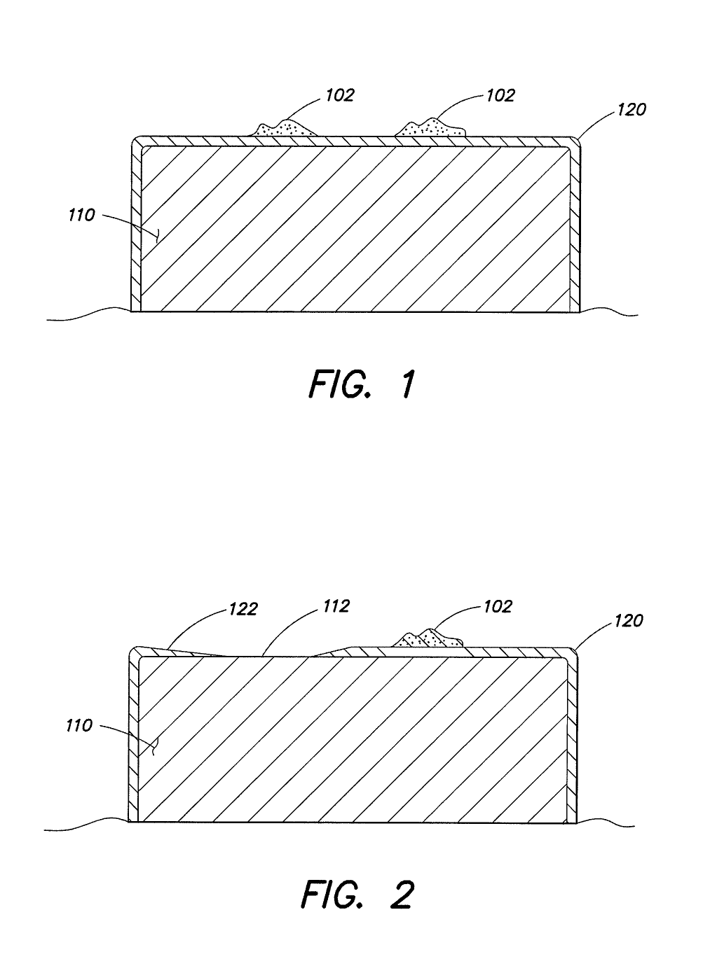

### DETAILED DESCRIPTION AND DISCUSSION OF INVENTION

Aspects of the present invention are directed to an improved protective tape for welding applications. The protective tape may be used to cover components around a welding location. As set forth in greater detail below, aspects of the present invention are directed to a welding tape that conforms closely to irregular surfaces. Other aspects relate to a tape which will adhere to surfaces that are contaminated, such as with an oil. Other aspects include methods for welding together metal components.

One particular application of this tape is in the welding of automobile components. The weld spatter may land on the protective tape rather than land on and bond to the surrounding components. When the welding is completed, the protective tape may be removed from the component. The weld spatter on the protective tape may be removed along with the protective tape without the need of grinding.

Turning to the drawings, it should be appreciated that the drawings illustrate various components and features which may be incorporated into various embodiments of the present invention. For simplification, some of the drawings may illustrate more than one optional feature or component. However, the present invention is not limited to the specific embodiments disclosed in the drawings. It should be recognized that the present invention encompasses embodiments which may include only a portion of the components illustrated in any one figure, and/or may also encompass embodiments combining components illustrated in multiple different drawings.

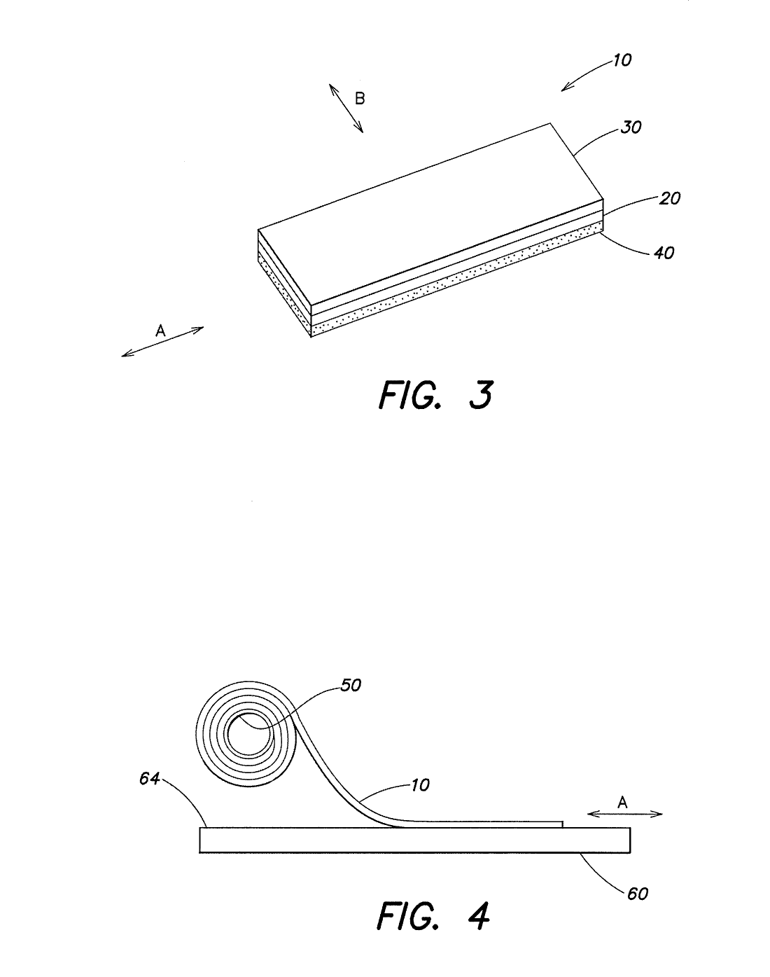

In one aspect as shown in FIG. 3, a protective tape useful for welding applications is disclosed. The protective tape 10 typically includes a non-metal carrier sheet 20 with a covering 30 on a first side of the carrier sheet 20 and an adhesive 40 on a second side of the carrier sheet 20. The adhesive 40 is constructed to adhere to a metal component around the site of a welding location, and the covering 30 is constructed to shield the carrier sheet 20 from weld spatter. It should be appreciated that in FIG. 3, the thickness of the tape is enlarged to better illustrate the different layers of the tape and is not representative of the actual thickness in comparison to the length or width of the tape segment.

As illustrated in FIG. 4, in one embodiment, the protective tape 10 is wound on a roll 50 and is unrolled as the tape 10 is applied to a component 60. As set forth in more detail below, in one embodiment, the roll of the protective tape 10 is configured to be dispensed from an applicator which may be automatically controlled, whereas in another embodiment, the tape 10 may be applied manually to a component 60.

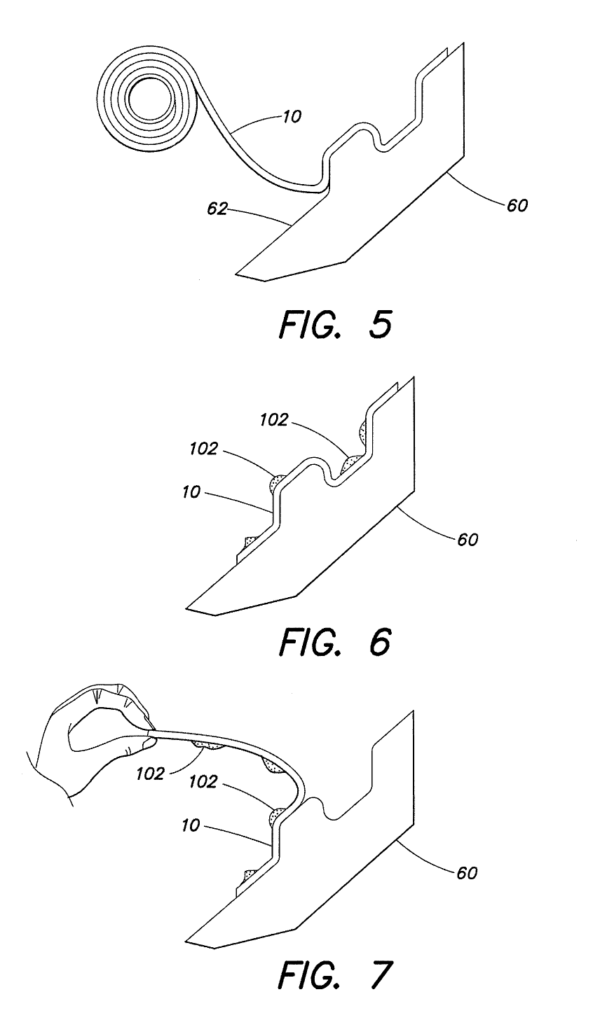

Although FIG. 4 illustrates the tape 10 being applied to a substantially planar surface 64, it should be appreciated that the invention is not so limited. As shown in FIGS. 5-7, aspects of the present invention are directed to a protective tape 10 configured to be applied to and conform to irregular surfaces 62, such as, but not limited to corners, non-planar surfaces, convex surfaces, concave surfaces, and/or other types of complex surfaces.

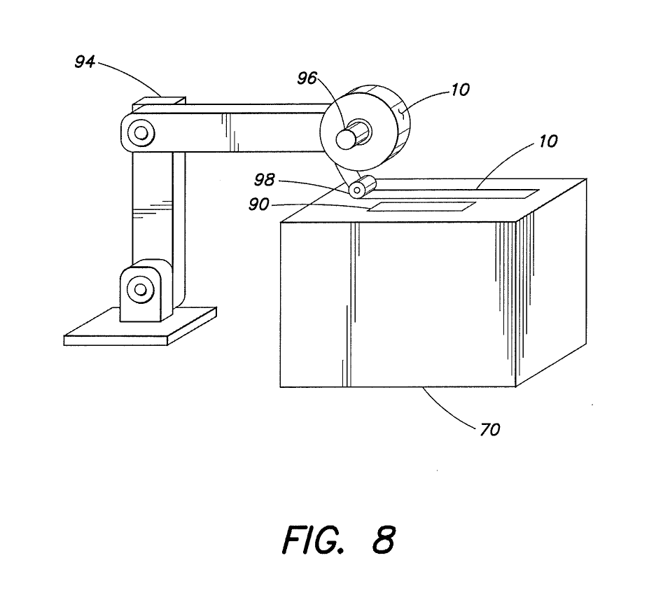

Unlike the above-described prior art protective tapes which have an aluminum carrier sheet, the non-metal carrier sheet 20 of the present invention is extensible in at least one direction and substantially flexible such that it may closely conform to irregular surfaces 62. Accordingly, the protective tape 10 is able to conform to and adhere to various contours of components 60 without creating substantial air pockets between the tape 10 and the component 60. As shown in FIG. 6, when the protective tape 10 is applied to a component 60, the tape 10 acts as a barrier layer between weld spatter 102 and the component 60. In this respect, when the protective tape 10 is removed, the weld spatter 102 may be removed along with the tape 10 (see FIG. 7).

In one embodiment, the carrier sheet 20 is mono-oriented such that the extensibility of the carrier sheet 20 is greater in one direction than in another direction. For example, in one embodiment, the carrier sheet 20 may be more extensible along the transverse direction or width of the tape (along arrow B in FIG. 3) than along the machine direction or length of the protective tape (along arrow A in FIGS. 3-4). In this embodiment, the carrier sheet 20 will stretch more along its width such that the carrier sheet 20 can conform to various irregular surfaces of a component. In another embodiment, the carrier sheet 20 may be more extensible along the length of the protective tape 10 (along arrow A in FIGS. 3 and 4) than in a direction parallel to the width of the tape (along arrow B in FIG. 3). In this embodiment, the carrier sheet 20 will stretch more along its length such that the carrier sheet 20 can conform to various irregular surfaces of a component 60. In yet another embodiment, the extensibility of the carrier sheet 20 in both the direction of the length and the width of the tape may be similar.

Another aspect of the present invention is directed to a protective tape 10 which is constructed so as to minimize any degradation of the tape 10 due to weld spatter. The degradation of the tape 10 may be prevented, at least in part, by the proper selection of the thickness, strength and melting temperature of the carrier sheet 20. For example, carrier sheet 20 may be heat resistant. Metal components are typically welded at high temperatures. In certain welding applications, a protective tape 10 placed around the welding location may be subject to temperatures up to 150° C., up to 200° C., up to 300° C. or even up to 350° C. Weld spatter may also approach these temperatures when it first contacts the protective tape 10. If the thickness, strength and/or melting temperature of the carrier sheet 20 is not sufficient to withstand this environment, the carrier sheet 20 may begin to melt which may degrade the protective tape 10. This may allow weld spatter to pass through the tape and contact the component 60. However, it should be recognized that in some embodiments, some melting of the protective tape 10 may be acceptable, so long as the weld spatter does not completely penetrate the tape 10 and reach the component 60.

In one embodiment, the carrier sheet 20 has a melting temperature of at least 150° C. In another embodiment, the carrier sheet 20 has a melting temperature of at least 200° C. In yet another embodiment, the carrier sheet 20 has a melting temperature of at least 250° C., and in yet further embodiments, the carrier sheet has a melting temperature of at least 300° C. or at least 350° C. When the carrier sheet 20 has a melting temperature that is higher than the welding temperature, the protective tape 10 is less likely to undesirably degrade.

As the protective tape 10 melts, the different layers of the tape 10 may melt, flowing away from the rest of the tape. When this occurs, the tape may be more difficult to cleanly remove from the component 60. For example, tape residue may stick to the component 60 after the protective tape is removed from the component. This is undesirable and this residue must be removed by using a solvent wash, scraping, grinding, or the like. In one embodiment, the protective tape 10 may reach temperatures at which it begins to melt when contacted with weld spatter. However, if the different tape layers do not melt enough to alter the original tape structure, when the protective tape 10 cools, the tape may still remove cleanly from the component with minimal tape residue.

The carrier sheet 20 may be formed from a variety of materials. In one embodiment, the carrier sheet 20 is made from a thermoplastic polymer. One example of a suitable thermoplastic polymer has a tensile strength between 9,000-40,000 lb/in², a tensile modulus between 375,000-425,000 lb/in², percent elongation between 50%-250% and melting temperature of 265° C. or greater. In one particular embodiment, a carrier sheet 20 that possesses these properties is nylon, such as DARTEK® nylon 6, 6, manufactured by DuPont. In nylon 6,6 at the molecular level, every repeating unit of the polymer chain has two stretches of carbon atoms, each being six carbon atoms long. Nylon 6, 6 is a desirable carrier sheet 20 material in part because of its high melting temperature and its inherent resistance to burning. In other embodiments, the carrier sheet 20 may be made with other thermoplastic polymers such as, but not limited, to polyethylene terephthalate glycol (PETG), polyether ether ketone (PEEK), polyphenylene sulfide (PPS), polyethylene naphthalate (PEN), polyphenylene oxide (PPO), polyarylsulfone (PAS), polyphenyl sulfone (PPSU), polysulfone (PSU), or polyvinyl fluoride (PVF).

The adhesive 40 is constructed to adhere to a metal component 60 at or near the site of a welding location. In one embodiment, the adhesive 40 is a pressure sensitive adhesive that adheres to the metal component with hand pressure. In some welding applications, the area around the welding location may be contaminated with various substances, such as oil. In some embodiments of the present invention, the adhesive is constructed to adhere to such oil contaminated surfaces. This is in contrast to the above-described prior art protective tapes which have an acrylic adhesive that does not adhere well to oil contaminated surfaces.

Applicants recognized that adhesives which are rubber-based or urethane-based adhere better to an oil contaminated surface than adhesives that are silicone-based or acrylic-based. Both rubber-based and urethane-based adhesives contain oil in their composition which helps the adhesive adhere to an oily surface. Other adhesives containing oil are also contemplated for use in the protective tape 10. Although rubber-based or urethane-based adhesives are preferred, certain embodiments may encompass acrylic-based adhesives. In certain embodiments, the adhesive 40 may be made with synthetic rubber-based adhesives, such as, but not limited to UPACO® SZ0507 sold by Upaco Industries Division of Worthen Industries, Inc., DURO-TAK® 36-6179 sold by National Starch and Chemical Company, CS1003C sold by Carlisle, PHL4167 sold by HB Fuller, Polytac 297 sold by Ashland, or 6806 sold by Henkel. One example of a suitable synthetic rubber-based adhesive has a static shear strength of at least 24 hours with a 2.2 psi dead load at 150° F., a density between 7.5-7.7 lbs/gal, and a viscosity between 6500-8500 cps. Another example of a suitable synthetic rubber-based adhesive has a density of about 7.4 lbs/gal and a viscosity of about 1850 cps.

In another aspect, the adhesive 40 removes substantially completely from the component 60 without leaving any significant residue as the protective tape 10 with weld spatter is peeled off. This result, in one embodiment, is achieved using a crosslinked adhesive so that the adhesive layer is a more cohesive layer. Applicants recognized that a protective tape 10 made with a crosslinked adhesive may be removed more easily from a component 60 than a protective tape with a non-crosslinked adhesive. As illustrated in FIG. 7, in certain embodiments, when a protective tape 10 with a crosslinked adhesive is removed from the component 60 substantially no adhesive residue remains on the component 60.

Various crosslinkers may be used with the adhesive 40, as the invention is not limited in this respect. Some representative crosslinkers include isocyanate, sulphur or aziridine. In one embodiment, the crosslinker may be either a polyfunctional isocyanate or a monomeric isocyanate. In another embodiment, the adhesive is crosslinked with a polymeric isocyanate, such as MORSTIK® 130 Adhesive, sold by Rohm Hass Company. In this particular embodiment, the adhesive includes 74-76% polymeric isocyanate, less than 0.5% toluene disocyanate and 24-26% ethyl acetate, and has a boiling point of approximately 77° C., an ignition temperature of 485° C., a relative density of 1.17 at 20° C., a viscosity between 8,000-13,000 cps, and a density of about 7.2 lbs/gal.

Unlike the above-described prior art protective tapes which only include a carrier sheet and an adhesive, the present invention may further include a covering 30 on the first side of the carrier sheet 20 that helps shield the carrier sheet from weld spatter. Covering 30 may serve dual functions of protecting against weld spatter and providing release as the tape is unwound. First, the covering 30 may act at least as a partial barrier to reduce the likelihood that molten weld spatter would pass through the protective tape 10. Second, the covering 30 may obviate the need for a release liner when the tape is dispensed from a roll. Covering 30 is typically formed as a low adhesion high release material from which the adhesive layer 40 will easily release. The adhesive layer 40 must release more readily from covering 30 than the carrier sheet 20.

In one embodiment, the covering 30 is a coating disposed on the first side of the carrier sheet 20, such as a silicone coating. A controlled release additive (CRA), such as an organosiloxane compound, may be added to the covering material to increase the surface energy of the covering 30. Different controlled release levels of the covering 30 may be achieved based upon the amount of the CRA that is added to the silicone. For example, a material that has a 2:1 ratio when a CRA is added has a greater amount of surface energy in comparison to the material without the CRA. Materials with 3:1 and 4:1 ratios, each having a greater amount of surface energy, are also contemplated as the present invention is not limited in this respect. In one embodiment, a CRA is added to the silicone covering 30 such that there is enough adhesion to provide a tight unwind of the tape 10. However, it should be appreciated that in other embodiments, the covering 30 may not include a CRA, as the invention is not so limited.

The covering 30 may be heat resistant such that the covering does not undesirably degrade at the welding temperature. In one embodiment, the covering 30 has a melting temperature of at least 200° C. In another embodiment, the covering 30 has a melting temperature of at least 250° C., and in further embodiments, the covering 30 has a melting temperature of at least 300° C., or at least 350° C. In these embodiments, the covering may be configured such that weld spatter 102 which approaches these temperatures does not completely melt the covering 30 or cause the weld spatter to pass through the covering 30. As discussed above, in some embodiments, the tape 10 may be configured such that some melting of the tape 10 may occur, so long as the weld spatter does not completely penetrate the tape 10.

Portions of the protective tape 10 may include coloring to indicate the presence of the protective tape 10 on the component 60 to assist in its removal. The coloring may be part of the carrier sheet 20, the covering 30, and/or the adhesive 40. In one embodiment, the adhesive 40 may be colored so that any adhesive residue left on the component 60 after removal of the tape 10 is easier to spot. However, it should be appreciated that in some embodiments, the protective tape 10 may not include a coloring, as the invention is not limited in this respect.

Due to certain welding conditions, in some embodiments, the protective tape 10 is flame retardant. In particular, in one embodiment, the protective tape is flame retardant when exposed to a direct flame while bonded to the component. In another embodiment, the protective tape 10 is self extinguishing in an unsupported vertical burn test, as set forth in UL 94 “Test for Flammability of Plastic Materials for Parts in Devices and Appliances” by Underwriters Laboratories Inc.

The dimensions of the protective tape 10 may vary as the invention is not limited in this respect. In one embodiment, the thickness of the carrier sheet 20 is approximately 0.5 mil to 3 mil, the thickness of the adhesive 40 is approximately 0.5 mil to 3 mil, and the thickness of the covering 30 is approximately 20-200 angstroms. In one particular embodiment, the protective tape 10 includes a nylon carrier sheet 20 with a thickness of approximately 1 mil, a rubber-based adhesive 40 with a thickness of approximately 1 mil, and a silicone covering 30 with a thickness of approximately 50 angstroms. In another embodiment, the protective tape 10 includes a nylon carrier sheet with a thickness of approximately 38 microns, a pressure sensitive adhesive with a thickness of approximately 50 microns, and a silicone covering with a thickness of approximately 90 angstroms. The width of a roll of protective tape 10 may be, for example, approximately 60 mm. In one embodiment, the width and length of each layer of the protective tape 10 is the same. In another embodiment, one or more layers of the protective tape 10 may extend out farther in the length or width direction in comparison to other tape layers. It should be appreciated that the dimensions of the protective tape 10 may vary based upon the particular application.

Another aspect of the invention is disclosed in FIG. 8 which is a schematic perspective view of a robotic tape applicator 94 that may be used to apply the protective tape 10 to a metal component 70. In this embodiment, the component 70 may form part of the outer body of an automobile, such as, for example, sheet metal. However, it should be appreciated that other embodiments of the present invention are directed to other welding applications, as the invention is not so limited.

The automated robotic applicator 94 may be semi or fully controlled. In the illustrated embodiment, the tape 10 is on a roll and the robotic applicator 94 includes two spindles 96, 98 which control the tension in the tape 10 as the tape 10 is applied to the component 70. Although FIG. 8 illustrates a robotic applicator 94, it should be appreciated that in another embodiment, the protective tape 10 may be applied manually to a component 70. Furthermore, it should also be recognized that the subsequent removal of the protective tape 10 from the component may also be performed either manually (see FIG. 7) or it may be automated, as the invention is not so limited.

Another aspect of the invention is a method of welding components, such as automobile components. Before the tape 10 is applied to the component 70, the component 70 may first be metal plated, such that an outer protective plating envelopes the component. For example, the component 70 may be zinc plated to prevent corrosion. After the plating, as shown in FIG. 8, a protective tape 10 is applied over at least a portion of the component 70 adjacent a welding location 90. Although the different layers of the protective tape 10 are not visible in FIG. 8, as discussed above, the protective tape 10 typically includes a non-metal carrier sheet 20, a covering 30 on a first side of the carrier sheet 20, and an adhesive 40 on a second side of the carrier sheet 20. The protective tape 10 is applied such that the carrier sheet 20 is extended and flexed to closely conform to any irregular surface of the metal component 70 and the adhesive 40 adheres to the metal component, to minimize the presence of any air pockets between tape 10 and the surface of component 70. The metal plated component 70 is then welded at the welding location 90 and the covering 30 on the protective tape 10 shields the carrier sheet 20 from weld spatter.

Thereafter, the protective tape 10 is removed from the component 70 such that weld spatter on the protective tape 10 is removed from the component 70 with the removal of the protective tape 10. In one embodiment, the protective tape 10 is removed from the component 70 such that substantially no adhesive residue remains on the component 70. In another embodiment, the protective tape 10 may be manually removed without the use of a tool to scrape the tape from the surface of component 70. It should be appreciated that although tape 10 is only applied to one component 70, in other embodiments, the protective tape 10 may be applied to two or more components around a welding location 90.

Having thus described several aspects of at least one embodiment of this invention, it is to be appreciated various alterations, modifications, and improvements will readily occur to those skilled in the art. Such alterations, modifications, and improvements are intended to be part of this disclosure, and are intended to be within the spirit and scope of the invention. Accordingly, the foregoing description and drawings are by way of example only.

What is claimed is:

1. A protective tape for use while welding together two metal components, the protective tape comprising:
a non-metal carrier sheet that is extensible and substantially flexible such that it closely conforms to irregular surfaces of a metal component, wherein the carrier sheet is heat resistant such that it has a melting temperature of at least 200° C.;
a covering on a first side of the carrier sheet that shields the carrier sheet from weld spatter; and
an adhesive on a second side of the carrier sheet that is constructed and arranged to adhere to the metal component.

2. The protective tape of claim 1, wherein the adhesive is crosslinked.

3. The protective tape of claim 2, wherein the adhesive is crosslinked with at least one of isocyanate, sulphur and aziridine.

4. The protective tape of claim 1, wherein the adhesive is rubber-based or urethane-based.

5. The protective tape of claim 4, wherein the adhesive is crosslinked with polymer isocyanate and is made of MORSTIK® 130 Adhesive.

6. The protective tape of claim 1, wherein the carrier sheet is mono-oriented such that the extensibility of the carrier sheet is greater in one direction than in another direction.

7. The protective tape of claim 1, wherein the carrier sheet is made of a thermoplastic polymer.

8. The protective tape of claim 1, wherein the carrier sheet is made of nylon.

9. The protective tape of claim 8, wherein the carrier sheet is made of DARTEK® nylon 6, 6.

10. The protective tape of claim 1, wherein the covering is a silicone coating.

11. The protective tape of claim 10, wherein the covering is a controlled release silicone coating.

12. The protective tape of claim 1, wherein the tape is wound up on a roll and is configured to be dispensed from an applicator.

13. The protective tape of claim 1, wherein at least one of the carrier sheet, adhesive, and covering is colored to indicate the presence of protective tape on the metal component.

14. The protective tape of claim 1, wherein the metal component is an automobile component.

15. The protective tape of claim 1, wherein the protective tape is flame retardant.

16. The protective tape of claim 1, in combination with a metal component, wherein the metal component includes sheet metal.

17. A protective tape for use while welding together two metal components, the protective tape comprising:
a non-metal carrier sheet that is extensible and substantially flexible such that it closely conforms to irregular surfaces of a metal component;
a covering on a first side of the carrier sheet that shields the carrier sheet from weld spatter; and
a crosslinked adhesive on a second side of the carrier sheet that is constructed and arranged to adhere to the metal component, wherein the adhesive is rubber-based or urethane-based.

18. The protective tape of claim 17, wherein the adhesive is crosslinked with at least one of isocyanate, sulphur and aziridine.

19. The protective tape of claim 17, wherein the carrier sheet is mono-oriented such that the extensibility of the carrier sheet is greater in one direction than in another direction.

20. The protective tape of claim 17, wherein the carrier sheet is made of a thermoplastic polymer.

21. The protective tape of claim 17, wherein the carrier sheet is made of nylon.

22. The protective tape of claim 17, wherein the carrier sheet is heat resistant such that it has a melting temperature of at least 200° C.

23. The protective tape of claim 17, wherein the covering is a silicone coating.

24. The protective tape of claim 23, wherein the covering is a controlled release silicone coating.

25. The protective tape of claim 17, wherein the tape is wound up on a roll and is configured to be dispensed from an applicator.

26. The protective tape of claim 17, wherein at least one of the carrier sheet, adhesive, and covering is colored to indicate the presence of protective tape on the metal component.

27. The protective tape of claim 17, wherein the metal component is an automobile component.

28. A method of welding metal components together, comprising:
metal plating a metal component;
providing a protective tape that includes a non-metal carrier sheet, a covering on a first side of the carrier sheet, and an adhesive on a second side of the carrier sheet;
applying the protective tape over at least a portion of the metal plated component adjacent a welding location, wherein the protective tape is applied such that the carrier sheet is extended and flexed to closely conform to an irregular surface of the metal component and the adhesive adheres to the metal component;
welding the metal plated component at the welding location, wherein the covering on the carrier sheet shields the carrier sheet from weld spatter; and
thereafter removing the protective tape from the component such that weld spatter on the protective tape is removed from the component with the removal of the protective tape.

29. The method of claim 28, wherein the metal plating is zinc plating.

30. The method of claim 28, wherein the protective tape is removed from the component such that substantially no adhesive residue remains on the component.

31. The method of claim 28, wherein the metal component is an automobile component.

32. The method of claim 28, wherein the metal component is welded at a temperature up to approximately 200° C.

33. The method of claim 28, wherein the protective tape is manually removed from the metal component.

34. In combination:
at least two metal components defining a welding location therebetween; and
a protective tape applied to at least one of the metal components adjacent the welding location, the protective tape comprising:
a non-metal carrier sheet that is extensible and substantially flexible such that it closely conforms to irregular surfaces of the metal component, wherein the carrier sheet is heat resistant such that it has a melting temperature of at least 200° C.;
a covering on a first side of the carrier sheet that shields the carrier sheet from weld spatter; and
an adhesive on a second side of the carrier sheet that is constructed and arranged to adhere to the metal component.

35. The combination of claim 34, wherein the protective tape is applied to the at least two metal components.

36. The combination of claim 34, wherein the adhesive is rubber-based or urethane-based.

37. The combination of claim 34, wherein the adhesive is crosslinked.
